(19) United States
(12) Patent Application Publication
(10) Pub. No.: US 2024/0220394 A1
(43) Pub. Date: Jul. 4, 2024

(54) METHOD AND APPARATUS FOR OUTPUTTING RUNNING DATA OF EFFECT

(71) Applicant: Beijing Zitiao Network Technology Co., Ltd., Haidian District, Beijing (CN)

(72) Inventors: Ruifeng MA, Beijing (CN); Weifeng HUANG, Beijing (CN); Xiaobo HUANG, Beijing (CN)

(21) Appl. No.: 18/567,250

(22) PCT Filed: May 10, 2022
(86) PCT No.: PCT/CN2022/091885

§ 371 Date: Dec. 5, 2023

(30) Foreign Application Priority Data
Jun. 29, 2021 (CN) 202110726968.2

(51) Int. Cl. G06F 11/36; G06F 11/32

(52) U.S. Cl. CPC G06F 11/3612; G06F 11/321

(57) ABSTRACT

Embodiments of the present disclosure provide a method and apparatus for outputting running data of effect, the method comprises: generating an effect package for a target effect, wherein the effect package comprises a monitoring list including at least one data object of the target effect; transmitting the effect package for the target effect to a running instance; receiving running data corresponding to each data object in the monitoring list transmitted from the running instance; and outputting the running data corresponding to each data object in the monitoring list.

### CROSS-REFERENCE OF RELATED APPLICATION

This disclosure claims the priority of a Chinese patent application No. 202110726968.2 filed in China Patent Office on Jun. 29, 2021, which is hereby incorporated by reference in its entirety.

### FIELD OF THE INVENTION

The invention relates to the technical field of effect processing, and in particular, to a method and apparatus for outputting running data of effect.

### BACKGROUND

With the continuous development of science and technology, effects are increasingly applied to selfie, short video production, film production, live video and other scenarios. The works processed by effects can surpass the visual effects that can be achieved by actual shooting, so effects provide strong technical support for improving the quality of works.

In general, the process of making an effect package includes: firstly, adding an effect resource file in the edit instance according to the requirements, and configuring a running logic for effects, and then packaging the effects resources and the running logic for effects to generate an effect package; then importing the effect package into the running instance for running so as to preview the effect. If the effect is normal, then the packaged effect package is directly published. If the effect is abnormal, it needs to return to the edit instance and modify the resource file or running logic for the effect in the edit instance, and regenerate the effect package and import the regenerated effect package into the running instance for running, until the effect is normal. In the process of configuring the running logic for effects, because editors can't observe the running data of effect, they can't intuitively judge whether there is abnormality in the running logic for effects and whether there are abnormal logic steps. When the effect is abnormal, the cause of the abnormal effect can't be quickly determined, which leads to low editing efficiency of effects and difficult debugging.

### DISCLOSURE OF THE INVENTION

In view of this, the present disclosure provides a method and apparatus for outputting running data of effect, which can solve a problem that the running data of effect cannot be observed in the process of editing the effect.

In order to achieve the above object, embodiments of the present disclosure provide the following technical schemes:

In a first aspect, an embodiment of the present disclosure provides a method for outputting running data of effect, wherein the method can be applied to an edit instance, and the method can include:

generating an effect package for a target effect, wherein the effect package includes a monitoring list, and the monitoring list includes at least one data object of the target effect;
transmitting the effect package for the target effect to a running instance;
receiving running data corresponding to each data object in the monitoring list transmitted from the running instance; and
outputting the running data corresponding to each data object in the monitoring list.

In an embodiment of the present disclosure, the method may further include:
receiving an editing operation input by a user for the effect package for the target effect;
editing the effect package for the target effect corresponding to the edit instance based on the editing operation, and transmitting an editing command to the running instance according to the editing operation, wherein the editing command is used for instructing the running instance to edit the effect package for the target effect corresponding to the running instance according to the editing operation;
receiving updated data transmitted by the running instance, wherein the updated data includes running data corresponding to each data object in the monitoring list acquired by the running instance running an updated effect package, and the updated effect package is an effect package obtained by the running instance editing the effect package for the target effect according to the editing operation; and
outputting the updated data.

In an embodiment of the present disclosure, wherein the generating the effect package for the target effect can include:
loading a resource file for the target effect;
displaying at least two logical nodes in response to a node adding operation input by a user;
acquiring an effect logic for the target effect in response to a connection operation by the user for node ports of the at least two logical nodes;
generating the monitoring list in response to at least one data object input by a user;
packaging the monitoring list, the resource file for the target effect, and the effect logic for the target effect to generate the effect package for the target effect.

In an embodiment of the present disclosure, wherein the monitoring list can further include an identifier of a node port of a logical node corresponding to each data object;
the receiving running data corresponding to each data object in the monitoring list transmitted from the running instance can include:
receiving running data corresponding to each data object in the monitoring list and the identifier of the node port of the logical node corresponding to each running data transmitted from the running instance.

In an embodiment of the present disclosure, wherein the identifier of a node port of a logical node corresponding to a data object can include:
an identifier of a node port of a logical node with the data object as input.

In an embodiment of the present disclosure, wherein the outputting the running data corresponding to each data object in the monitoring list can include:
according to the identifier of the node port of the logical node corresponding to each running data, displaying each running data in the data display area corresponding to the node port.

In a second aspect, an embodiment of the present disclosure provides a method for outputting running data of effect, wherein the method is applied to a running instance, and the method can include:
receiving an effect package for a target effect transmitted from an edit instance, wherein the effect package includes a monitoring list, and the monitoring list includes at least one data object of the target effect;
running the effect package, to acquire running data corresponding to each data object in the monitoring list;
transmitting the running data corresponding to each data object in the monitoring list to the edit instance, so that the edit instance outputs the running data corresponding to each data object in the monitoring list.

In an embodiment of the present disclosure, the method can further include:
receiving an editing command transmitted from the edit instance, wherein the editing command is used for instructing the running instance to edit the effect package for the target effect corresponding to the running instance according to the editing operation;
editing the effect package for the target effect corresponding to the edit instance based on the editing operation, to generate an updated effect package;
running the updated effect package to acquire updated data, wherein the updated data includes running data corresponding to each data object in the monitoring list acquired by running the updated effect package, and transmitting the updated data to the edit instance.

In an embodiment of the present disclosure, wherein the monitoring list can further include an identifier of a node port of a logical node corresponding to each data object;
the transmitting the running data corresponding to each data object in the monitoring list to the edit instance can include:
transmitting the edit instance running data corresponding to each data object in the monitoring list and the identifier of the node port of the logical node corresponding to each running data.

In a third aspect, an embodiment of the present disclosure provides a method for outputting running data of effect, including:
generating, by an edit instance, an effect package for a target effect, wherein the effect package includes a monitoring list, and the monitoring list includes at least one data object of the target effect;
transmitting, by the edit instance, the effect package for the target effect to a running instance;
running, by the running instance, the effect package, to acquire running data corresponding to each data object in the monitoring list;
transmitting, by the running instance, the running data corresponding to each data object in the monitoring list to the edit instance, and
outputting, by the edit instance, the running data corresponding to each data object in the monitoring list.

In a fourth aspect, an embodiment of the present disclosure provides an apparatus for outputting running data of effect, wherein an edit instance runs on the apparatus, and the apparatus can include:
a generation unit configured to generate an effect package for a target effect, wherein the effect package includes a monitoring list, and the monitoring list includes at least one data object of the target effect;
a transmission unit configured to transmit the effect package for the target effect to a running instance;
a receiving unit configured to receive running data corresponding to each data object in the monitoring list transmitted from the running instance; and
an output unit configured to output the running data corresponding to each data object in the monitoring list.

In an embodiment of the present disclosure, the apparatus may further include:
an user input unit configured to receive an editing operation input by a user for the effect package for the target effect;
an editing unit configured to edit the effect package for the target effect corresponding to the edit instance based on the editing operation, and
the transmission unit can be further configured to transmit an editing command to the running instance according to the editing operation, wherein the editing command is used for instructing the running instance to edit the effect package for the target effect corresponding to the running instance according to the editing operation;
the receiving unit can be further configured to receive updated data transmitted by the running instance, wherein the updated data includes running data corresponding to each data object in the monitoring list acquired by the running instance running an updated effect package, and the updated effect package is an effect package obtained by the running instance editing the effect package for the target effect according to the editing operation; and
the output unit can be further configured to output the updated data.

In an embodiment of the present disclosure, wherein the generation unit can be further configured to load a resource file for the target effect; display at least two logical nodes in response to a node adding operation input by a user; acquire an effect logic for the target effect in response to a connection operation by the user for node ports of the at least two logical nodes; generate the monitoring list in response to at least one data object input by a user; package the monitoring list, the resource file for the target effect, and the effect logic for the target effect to generate the effect package for the target effect.

In an embodiment of the present disclosure, wherein the monitoring list can further include an identifier of a node port of a logical node corresponding to each data object;
the receiving unit can be further configured to receive running data corresponding to each data object in the monitoring list and the identifier of the node port of the logical node corresponding to each running data transmitted from the running instance.

In an embodiment of the present disclosure, wherein the identifier of a node port of a logical node corresponding to a data object can include:
an identifier of a node port of a logical node with the data object as input.

In an embodiment of the present disclosure, wherein the outputting unit can be further configured to:
according to the identifier of the node port of the logical node corresponding to each running data, display each running data in the data display area corresponding to the node port.

In a fifth aspect, an embodiment of the present disclosure provides an apparatus for outputting running data of effect, wherein a running instance runs on the apparatus, and the apparatus can include:
a receiving unit configured to receive an effect package for a target effect transmitted from an edit instance, wherein the effect package includes a monitoring list, and the monitoring list includes at least one data object of the target effect;
an acquisition unit configured to acquire running data corresponding to each data object in the monitoring list by running the effect package;
a transmission unit configured to transmit the running data corresponding to each data object in the monitoring list to the edit instance, so that the edit instance outputs the running data corresponding to each data object in the monitoring list.

In an embodiment of the present disclosure, the apparatus can further include an editing unit;
the receiving unit can be further configured to receive an editing command transmitted from the edit instance, wherein the editing command is used for instructing the running instance to edit the effect package for the target effect corresponding to the running instance according to the editing operation;
the editing unit can be further configured to edit the effect package for the target effect corresponding to the edit instance based on the editing operation, to generate an updated effect package;
the acquisition unit can be further configured to run the updated effect package to acquire updated data, wherein the updated data includes running data corresponding to each data object in the monitoring list acquired by running the updated effect package, and
the transmission unit can be further configured to transmit the updated data to the edit instance.

In an embodiment of the present disclosure, wherein the monitoring list can further include an identifier of a node port of a logical node corresponding to each data object;
the transmission unit can be further configured to transmit the edit instance running data corresponding to each data object in the monitoring list and the identifier of the node port of the logical node corresponding to each running data.

In a sixth aspect, an embodiment of the present disclosure provides an apparatus for outputting running data of effect, wherein an edit instance and a running instance run on the apparatus, and the apparatus can include:
a generation unit configured to generate, by the edit instance, an effect package for a target effect, wherein the effect package includes a monitoring list, and the monitoring list includes at least one data object of the target effect;
a first transmission unit configured to transmit, by the edit instance, the effect package for the target effect to a running instance;
a first receiving unit configured to receive, by the running instance, the effect package for the target effect transmitted from the edit instance;
an acquisition unit configured to acquire running data corresponding to each data object in the monitoring list by the running instance running the effect package;
a second transmission unit configured to transmit, by the running instance, the running data corresponding to each data object in the monitoring list to the edit instance,
a second receiving unit configured to receive, by the edit instance, running data corresponding to each data object in the monitoring list transmitted from the running instance, and
an output unit configured to output, by the edit instance, the running data corresponding to each data object in the monitoring list.

In a seventh aspect, an embodiment of the present disclosure provides an electronic device including: a memory and a processor, wherein the memory is used for storing a computer program; the processor, when executing the computer program, causes the electronic device to implement the method for outputting running data of effect provided by any one of above embodiments.

In an eighth aspect, an embodiment of the present disclosure provides a computer-readable storage medium having a computer program stored thereon, the computer program, when executed by a computing device, causes the computing device to implement the method for outputting running data of effect provided by any one of above embodiments.

In a ninth aspect, an embodiment of the present disclosure provides a computer program product which, when running on a computer, causes the computer to implement the method for outputting running data of effect provided by any one of above embodiments.

In a tenth aspect, an embodiment of the present disclosure also provides a computer program, which includes program codes that, when executed by a computer, cause the computer to implement the method for outputting running data of effect provided by any one of above embodiments.

The method for outputting running data of effect provided by an embodiment of the present disclosure may include: an edit instance generating an effect package including a monitoring list and then transmitting the effect package to a running instance, then receiving running data corresponding to each data object in the monitoring list transmitted from the running instance; and outputting the running data corresponding to each data object in the monitoring list. On basis of the method for outputting running data of effect provided by the embodiment of the present disclosure, an effect editor can add a group of data objects that is desired to be observed into the effect package, and by the running instance, acquire the running data corresponding to each data object and transmit the running data corresponding to each data object to the edit instance, and the edit instance will also output the running data corresponding to each data object, so that the effect editor can intuitively observe the running data they want to observe through the method for outputting running data of effect provided by the embodiment of the present disclosure, thereby improving the editing efficiency for effects and reducing the debugging difficulty for effects.

### DESCRIPTION OF THE DRAWINGS

The accompanying drawings, which are incorporated in and constitute a part of this specification, illustrate embodiments consistent with the present disclosure and together with the description, serve to explain the principles of the present disclosure.

In order to explain the technical schemes in embodiments of the present disclosure or the prior art more clearly, the drawings needed in the description of the embodiments or the prior art will be briefly introduced below. It is obvious for those ordinary skilled in the art that other drawings can be obtained according to these drawings without paying creative labor.

FIG. 1 is a schematic scenario architecture diagram of a method for outputting running data of effect according to an embodiment of the present disclosure;

FIG. 2 is a schematic scenario architecture diagram of a method for outputting running data of effect according to an embodiment of the present disclosure;

FIG. 3A shows an interactive operation in outputting running data of effect according to an embodiment of the present disclosure, and FIGS. 3B and 3C show a flowchart of steps of a method for outputting running data of effect according to an embodiment of the present disclosure;

FIG. 4A shows an interactive operation in outputting running data of effect according to an embodiment of the present disclosure, and FIGS. 4B and 4C show a flowchart of steps of a method for outputting running data of effect according to an embodiment of the present disclosure;

FIG. 5 is a schematic interface diagram of a method for outputting running data of effect according to an embodiment of the present disclosure;

FIG. 6 is a flowchart of steps of a method for outputting running data of effect according to an embodiment of the present disclosure;

FIG. 7 is a schematic diagram of an apparatus for outputting running data of effect according to an embodiment of the present disclosure;

FIG. 8 is a schematic diagram of an apparatus for outputting running data of effect according to an embodiment of the present disclosure;

FIG. 9 is a schematic diagram of an apparatus for outputting running data of effect according to an embodiment of the present disclosure;

FIG. 10 is a schematic diagram of an apparatus for outputting running data of effect according to an embodiment of the present disclosure;

FIG. 11 is a schematic diagram of an apparatus for outputting running data of effect according to an embodiment of the present disclosure;

FIG. 12 is a schematic hardware structure diagram of an electronic device according to an embodiment of the present disclosure.

### DETAILED DESCRIPTION OF PREFERRED EMBODIMENTS

In order to understand the above objects, features and advantages of the present disclosure more clearly, the scheme of the present disclosure will be further described below. It should be noted that the embodiments of the present disclosure and the features in the embodiments can be combined with each other without conflict.

In the following description, many specific details are set forth in order to fully understand the present disclosure, but the present disclosure may be practiced in other ways than those described herein; obviously, the embodiments in the specification are only part of the embodiments of the present disclosure, not all of them.

The terms “first” and “second” in the specification and claims of this disclosure are used to distinguish synchronized objects, instead of describing a specific order of objects. For example, the first transmission unit and the second transmission unit are used to distinguish different transmission units, instead of indicating the specific order of transmission units.

In embodiments of the present disclosure, the words “exemplary” or “for example” are used to express as examples, illustrations or explanations. Any embodiment or design scheme described as “exemplary” or “for example” in the embodiments of the present disclosure should not be interpreted as being more preferred or advantageous than other embodiments or design schemes. To be exact, the usage of words such as “exemplary” or “for example” aims to present related concepts in a concrete way. In addition, in the description of the embodiments of the present disclosure, the meaning of “a plurality of” refers to two or more, unless otherwise specified.

Hereinafter, a scenario architecture for a method for outputting running data of effect according to an embodiment of the present disclosure will be first described below.

Referring to FIG. 1, a possible scenario architecture for the method for outputting running data of effect according to an embodiment of the present disclosure includes a first terminal device 11 and a second terminal device 12. Among them, the first terminal device 11 runs an edit instance 110 for editing the effect package for the effect thereon, and the second terminal device 12 runs a running instance 120 for running the effect package for the effect thereon, and a network connection is established between the first terminal device 11 and the second terminal device 12. The edit instance 110 and the running instance 120 can transmit data through the network connection between the first terminal device 11 and the second terminal device 12.

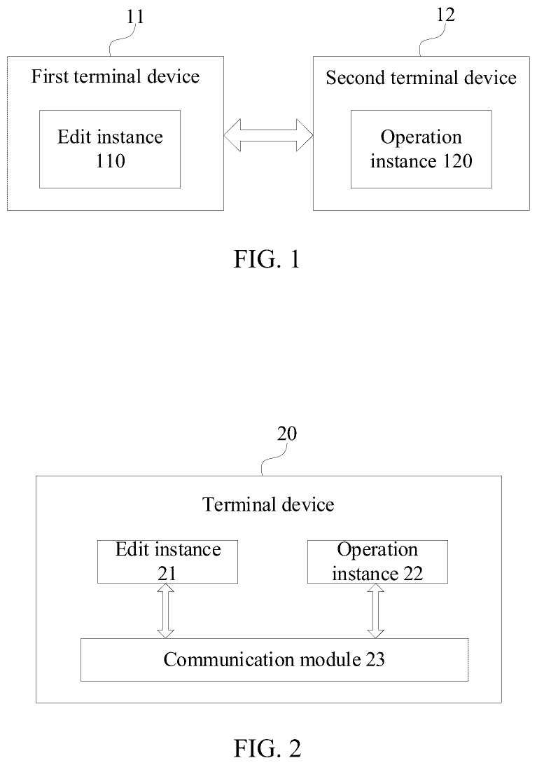

Referring to FIG. 2, another possible scenario architecture for the method for outputting running data of effect according to an embodiment of the present disclosure includes a terminal device 20. Among them, the terminal device 20 runs an edit instance 21 for editing the effect package for the effect, a running instance 22 for running the effect package for the effect and a communication module 23 thereon. Data can be transmitted between the edit instance 21 and the running instance 22 through the communication module 23. The communication module 23 may include a bus or a socket interface for the terminal device 20.

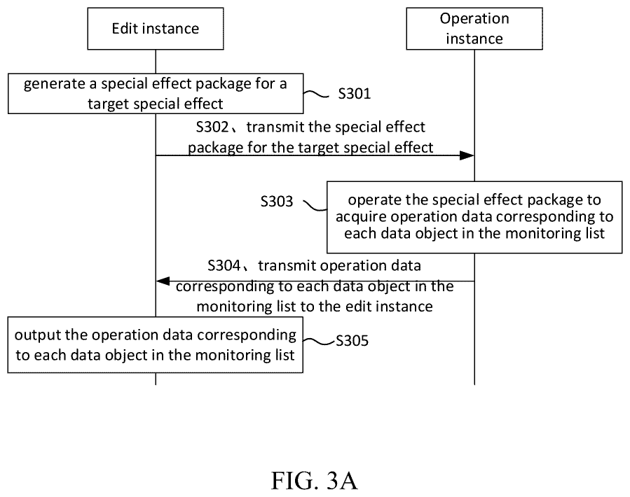

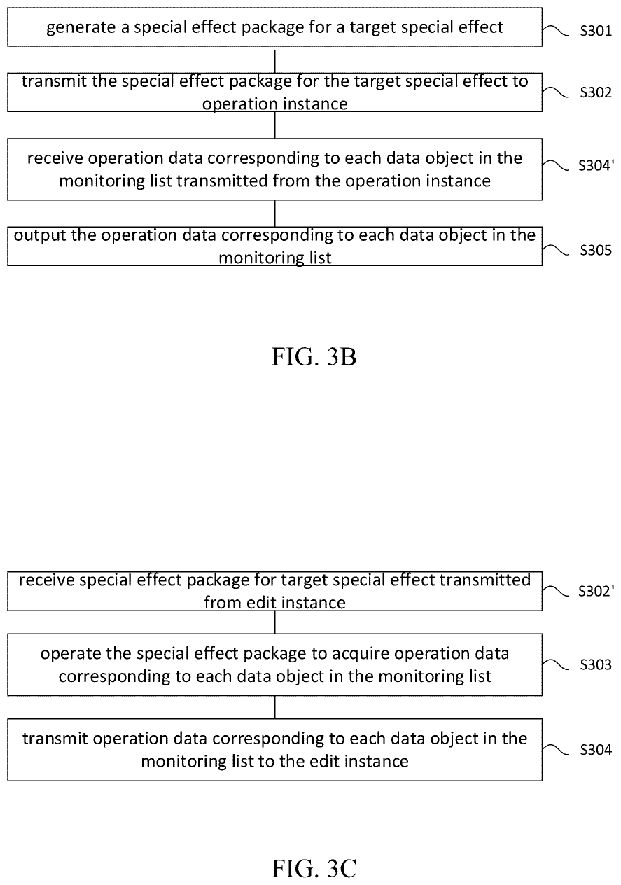

On the basis of the above, the embodiment of the present disclosure provides a method for outputting running data of effect. FIG. 3A shows an interactive operation in outputting running data of effect according to an embodiment of the present disclosure, referring to FIG. 3A, the basic operation of outputting running data of effect according to an embodiment of the present disclosure includes the following steps:
S301: an edit instance generates an effect package for the target effect.

Wherein the effect package can include a monitoring list, and the monitoring list can include at least one data object of the target effect.

Specifically, the edit instance generating an effect package for the target effect is usually realized in a manner of editing a script, so when an edit instance edits a script corresponding to the effect package, a data object to be observed can be added to a relevant script fragment in the script corresponding to the effect package, and thus a monitoring list can be added to the effect package. That is, the monitoring list in the embodiment of the present disclosure may be a script fragment including at least one data object.
S302: the edit instance transmits the effect package for the target effect to a running instance.

Correspondingly, the running instance receives the effect package for the target effect transmitted from the edit instance.

Optionally, in the embodiment of the present disclosure, the edit instance transmitting the effect package for the target effect to the running instance can be implemented as follows:

The edit instance synchronizes the effect package for the target effect to the running instance through a data synchronization function between instances.

Specifically, the data synchronization function between instances can be realized based on network communication or through a communication mechanism inside the device, which is not limited by the embodiments of the present disclosure.

Optionally, in the embodiment of the present disclosure, the edit instance transmitting the effect package for the target effect to the running instance can be implemented as follows:

The edit instance exports the effect package for the target effect to a preset storage location, and then the running instance reads the effect package for the target effect from the preset storage location.
S303: the running instance runs the effect package to acquire running data corresponding to each data object in the monitoring list.

Specifically, because the effect package includes the monitoring list, and the monitoring list includes at least one data object of the target effect, the running instance can parse the effect package to determine each data object in the monitoring list, and read the running data corresponding to each data object in the monitoring list when running the effect package, so as to acquire the running data corresponding to each data object in the monitoring list.

It should be noted that in the embodiment of this disclosure, the running data can be any type of data, for example, the running data can include: position coordinates, color values, one-dimensional vectors, two-dimensional vectors, Boolean values, hash values, numerical values in numerical operations, elements in logical operations, state data used to characterize the operation state of effect, etc., and the type of running data is not limited in this embodiment of the present disclosure.
S304: the running instance transmits running data corresponding to each data object in the monitoring list to the edit instance.

Correspondingly, the edit instance receives the running data corresponding to each data object in the monitoring list transmitted from the running instance.

Similarly, the implementation manner of the running instance transmitting running data corresponding to each data object in the monitoring list to the edit instance can include: the running instance can synchronize the running data corresponding to each data object in the monitoring list to the edit instance through a data synchronization function between instances, or the running instance can export the running data corresponding to each data object in the monitoring list to a preset storage location, and then the edit instance can read the running data corresponding to each data object in the monitoring list from the preset storage location.
S305: the edit instance outputs the running data corresponding to each data object in the monitoring list.

The method for outputting running data of effect provided by an embodiment of the present disclosure may include: an edit instance generating an effect package including a monitoring list and then transmitting the effect package to a running instance, then receiving running data corresponding to each data object in the monitoring list transmitted from the running instance; and outputting the running data corresponding to each data object in the monitoring list. On basis of the method for outputting running data of effect provided by the embodiment of the present disclosure, an effect editor can add a group of data objects that is desired to be observed into the effect package, and by the running instance, acquire the running data corresponding to each data object and transmit the running data corresponding to each data object to the edit instance, and the edit instance will also output the running data corresponding to each data object, so that the effect editor can intuitively observe the running data they want to observe through the method for outputting running data of effect provided by the embodiment of the present disclosure, thereby improving the editing efficiency for effects and reducing the debugging difficulty for effects.

FIG. 3B shows a method for outputting running data of effect according to an embodiment of the present disclosure, which can be mainly applied to an edit instance and may include the following steps:
In step S301, an effect package for a target effect is generated, wherein the effect package includes a monitoring list, and the monitoring list includes at least one data object of the target effect;
In step S302, the effect package for the target effect is transmitted to a running instance;
In step S304′, running data corresponding to each data object in the monitoring list transmitted from the running instance is received;
In step S305, the running data corresponding to each data object in the monitoring list is output. It should be noted that these steps can be performed as described above with reference to FIG. 3A, and in particular, step S304′ can be performed corresponding to that described in step S304.

FIG. 3C shows a method for outputting running data of effect according to an embodiment of the present disclosure, which can be mainly applied to a running instance and may include the following steps:
In step S302′, an effect package for a target effect transmitted from an edit instance is received, wherein the effect package includes a monitoring list, and the monitoring list includes at least one data object of the target effect;
In step S303, the effect package runs, to acquire running data corresponding to each data object in the monitoring list;
In step S304, the running data corresponding to each data object in the monitoring list is transmitted to the edit instance, so that the edit instance outputs the running data corresponding to each data object in the monitoring list. It should be noted that these steps can be performed as described above with reference to FIG. 3A, and in particular, step S302′ can be performed corresponding to that described in step S302.

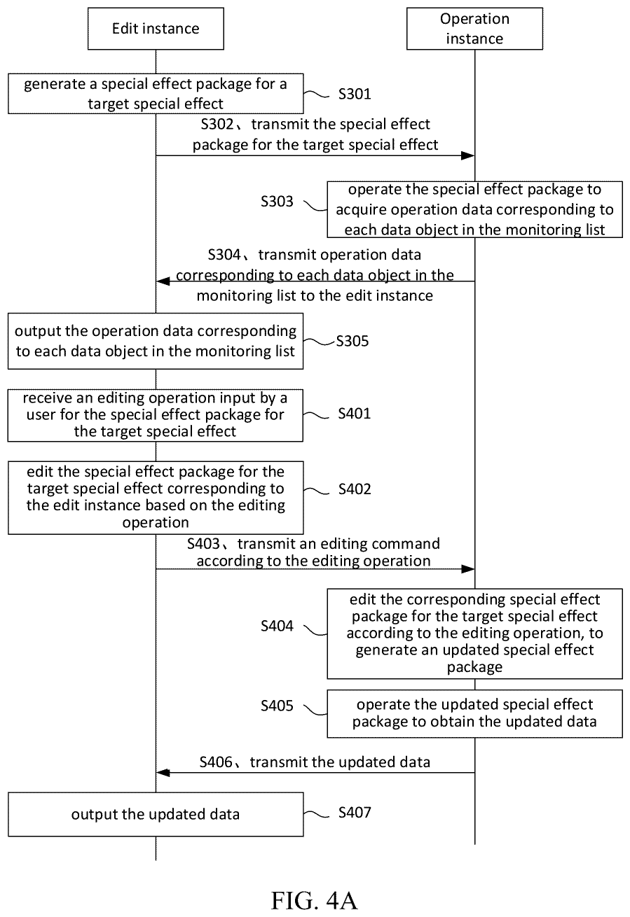

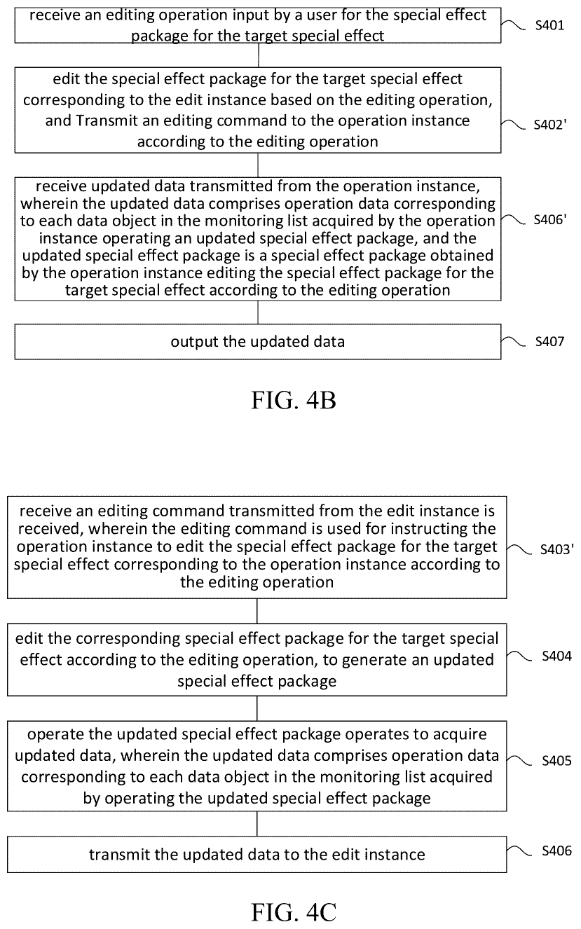

Further, on the basis of the above embodiments, the operation of outputting the running data of effect according to an embodiment of the present disclosure may further include further processing/steps. FIG. 4A shows a further interactive operation in outputting running data of effect according to an embodiment of the present disclosure. Referring to FIG. 4A, on the basis of the above embodiment, the operation of outputting the running data of effect according to an embodiment of the present disclosure may further include:
S401: the edit instance receives an editing operation input by the user for the effect package for the target effect.

The editing operation in an embodiment of the present disclosure may specifically include: an editing operation of adding an object, an editing operation of deleting an object, an editing operation of modifying an attribute value of an object, etc. The editing operation is not limited in embodiments of the present disclosure, and may include one or more of the above editing operations.
S402: the edit instance edits the effect package for the target effect corresponding to the edit instance based on the editing operation.

In an embodiment of the present disclosure, the effect package for the target effect corresponding to the edit instance may refer to the effect package for the target effect loaded by the edit instance. In the editing scenario, all kinds of editing operations input by the effect editor to the effect package for the target effect are performed for the effect package for the target effect corresponding to the edit instance.
S403: the edit instance transmits an editing command to the running instance according to the editing operation.

Correspondingly, the running instance receives the editing command transmitted from the editing operation.

Wherein, the editing command is used for instructing the running instance to edit the effect package for the target effect corresponding to the running instance according to the editing operation.

Different from the effect package for the target effect corresponding to the edit instance, in the embodiment of this disclosure, the effect package for the target effect corresponding to the running instance can refer to the effect package for the target effect loaded by the running instance, and the running instance can output the target effect according to the effect package for the target effect corresponding to the running instance, so that the effect editor can view the effect in real time, but the editing operation input by the effect editor for the effect package for the target effect will not be directly applied to the effect package for the target effect corresponding to the running instance, but will be applied to the effect package for the target effect corresponding to the edit instance.

Optionally, the implementation of the edit instance transmitting an editing command to the running instance according to the editing operation may include:

The edit instance transmits the editing command to the running instance periodically, with the period being a preset duration.

For example, the preset duration may be 100 ms, 200 ms, etc., which is not limited in the present disclosure.

Optionally, the implementation of the edit instance transmitting an editing command to the running instance according to the editing operation may further include:

The edit instance transmits an editing command corresponding to each editing operation to the running instance.

That is, every time the edit instance receives an editing operation, the edit instance can immediately generate and then transmit a corresponding editing command to the running instance, and upon receipt of a plurality of continuous editing operations, the edit instance can transmit a plurality of continuous editing commands to the running instance.
S404: the running instance edits the effect package for the target effect corresponding to the running instance according to the editing operation, to generate an updated effect package.

Since the editing operation performed by the running instance on the effect package for the target effect is the same as that performed by the edit instance on the effect package for the target effect, the essence of the above steps S401 to S404 lies in that the edit instance synchronizes the modification to the corresponding effect package for the target effect to the effect package for the target effect corresponding to the running instance.
S405: The running instance runs the updated effect package to obtain the updated data.

Wherein, the updated data can include running data corresponding to each data object in the monitoring list acquired by the running instance running the updated effect package.

That is, the running instance runs the effect package for the target effect after execution of the editing operation, re-acquires the running data corresponding to each data object in the monitoring list, and takes the re-acquired running data as the updated data.
S406: the running instance transmits the updated data to the edit instance.

Correspondingly, the edit instance receives the updated data transmitted from the running instance.

Optionally, the transmission of the updated data between the running instance and the edit instance can be implemented through a data synchronization function between the instances.
S407: The edit instance outputs the updated data.

FIG. 4B shows a method for outputting the running data of effect according to an embodiment of the present disclosure, which can be mainly applied to the edit instance, and on the basis of the aforementioned method, the method may further include:
In step S401, an editing operation input by a user for the effect package for the target effect is received;
In step S402′, the effect package for the target effect corresponding to the edit instance is edited based on the editing operation, and an editing command is transmitted to the running instance according to the editing operation, wherein the editing command is used for instructing the running instance to edit the effect package for the target effect corresponding to the running instance according to the editing operation;
In step S406′, updated data transmitted from the running instance is received, wherein the updated data comprises running data corresponding to each data object in the monitoring list acquired by the running instance running an updated effect package, and the updated effect package is an effect package obtained by the running instance editing the effect package for the target effect according to the editing operation;
In step S407, the updated data is output.

It should be noted that these steps can be performed as described above with reference to FIG. 4A, and in particular, steps S402′ and S406′ can be performed corresponding to those described in steps S402 and S406. It should be pointed out that the method embodiment shown in FIG. 4B can be combined with other embodiments of the present disclosure, especially with the method embodiment shown in FIG. 3B.

FIG. 4C shows a method for outputting running data of effect according to an embodiment of the present disclosure, which can be mainly applied to a running instance, and on the basis of the aforementioned method, the method may further include:
In step S403′, an editing command transmitted from the edit instance is received, wherein the editing command is used for instructing the running instance to edit the effect package for the target effect corresponding to the running instance according to the editing operation;
In step S404, the effect package for the target effect corresponding to the edit instance is edited based on the editing operation, to generate an updated effect package;
In step S405, the updated effect package runs to acquire updated data, wherein the updated data comprises running data corresponding to each data object in the monitoring list acquired by running the updated effect package;
In step S406, the updated data is transmitted to the edit instance.

It should be noted that these steps can be performed as described above with reference to FIG. 4A, and in particular, step S403′ can be performed corresponding to that described in step S403. It should be pointed out that the method embodiment shown in FIG. 4C can be combined with other embodiments of the present disclosure, especially with the method embodiment shown in FIG. 3C.

The method for outputting the running data of effect provided in the above embodiments can transmit an editing command to the running instance when an editor edits the effect package, wherein the editing command instructs the running instance to edit the effect package corresponding to the running instance according to the editing operation, and after running the edited effect package, the running instance will transmit the updated data to the edit instance, therefore, by adopting the above embodiment, the edited running data can be observed in real time while avoiding frequent exporting of the effect packages, and the real-time performance of observing the effect running data can be improved.

In an embodiment of the present disclosure, the step S301 (generating the effect package for the target effect) can be implemented as including the following steps a to e:
Step a, loading a resource file for the target effect.

Specifically, the resource file for the target effect may include materials, parameters, etc. for generating the target effect. Among them, the materials for the target effect may include animation, images, texts, etc., which is not limited in the embodiment of the present disclosure.
Step b, in respondence to the node addition operation input by the user, displaying at least two logical nodes.

That is, at least two logical nodes for configuring the target effect are selected from predefined logical nodes.

The node addition operation can specifically include one or more of touch click operation, long press operation, operation of selection in a drop-down menu, and special gesture. The user in the embodiment of the present disclosure may be an editor of effects.
Step c, in response to the user's connection operation for node ports of the at least two logical nodes, acquiring an effect logic for the target effect.

That is, the user can configure the effect logic for the target effect through connecting the node ports of at least two logical nodes. For example, the user connects the output node port A of the logical node 1 and the input node port B of the logical node 2 through the connection operation, the acquired effect logic for the target effect includes: taking the running data output by the node port A as the input of the node port B.

In the above embodiment, in the process of generating the effect logic for the target effect, the editor for the effect only needs to add the predefined logical nodes to the script area and configure the data flow between the nodes through the connection lines between the node ports, without needing to input any text code, so the editor can automatically generate program codes that conform to the running logic for the effect, therefore, the above embodiment can simplify the writing of the program code related to the effect.
Step d, generating the monitoring list in response to at least one data object input by the user.

For example, the manner of the user inputting at least one data object can include: typing the identifier of the data object to be observed through a physical keyboard, a virtual keyboard or the like, or the user selecting the data object to be observed among the data objects of the target effect.
Step e, packaging the monitoring list, the resource file for the target effect and the effect logic for the target effect to generate an effect package for the target effect.

In an embodiment of the present disclosure, the monitoring list may also include an identifier of a node port of a logical node corresponding to each data object.

That is, the monitoring list may include at least one data object and the identifier of the node port of the logical node corresponding to each data object.

An exemplary table entry structure of the monitoring list may be as follows:

(“Identifier of Node Port of Logical Node”−“Data Object”).

Optionally, the identifier of the node port of the logical node corresponding to a data object includes:

Identifier of the node port of the logical node with the data object as input.

Illustratively, the identifier of a node port may include an Identity Document (ID) of the node port.

For example, a data object in an effect logic will be input to the input port b1 of the logical node B from the output port a2 of the logical node A, and the identifier of the node port of the logical node corresponding to the data object is the identifier of the input port b1 of the logical node B.

It should be noted that since a data object can be used as the input to a plurality of logical nodes, there can be one or more identifiers for the node ports of logical nodes corresponding to running data. For example, the identifier of the node port of the logical node corresponding to data object A is 100, and the running data corresponding to data object A is (125,0,255), then the identifier of the node port of the logical node corresponding to running data (125,0,255) is 100.

Under the condition that the monitoring list may also include the identifier of the node port of the logical node corresponding to each data object, the running instance transmitting the running data corresponding to each data object in the monitoring list to the edit instance, may include:
transmitting the edit instance running data corresponding to each data object in the monitoring list and the identifier of the node port of the logical node corresponding to each running data.

Correspondingly, the receiving running data corresponding to each data object in the monitoring list transmitted from the running instance may include:
the edit instance receiving running data corresponding to each data object in the monitoring list and the identifier of the node port of the logical node corresponding to each running data transmitted from the running instance.

Exemplary, the data structure of the data transmitted from the running instance to the edit instance is as follows:

(“Identifier of Node Port of Logical Node”−“Running data”)

In an actual usage process, an editor may need to view multiple data objects, if only the running data corresponding to the data objects are output, the editor needs to determine the data object corresponding to each running data one by one, or even cannot determine the data objects corresponding to the running data, which is time-consuming and laborious. The above embodiment adds the identifier of the node port of the logical node corresponding to each data object to the monitoring list, and the running instance will also transmit the identifier of the node port of the logical node corresponding to each running data to the edit instance, in addition to transmitting the running data to the edit instance, so the above embodiment can show the node port identifier of the logical node corresponding to the running data to the editor, and the editor can quickly determine the node port of the logical node corresponding to the running data.

In an embodiment of the present disclosure, the above step S305 (outputting the running data corresponding to each data object in the monitoring list) may include:
according to the identifier of the node port of the logical node corresponding to each running data, displaying each running data in a data display area corresponding to the node port.

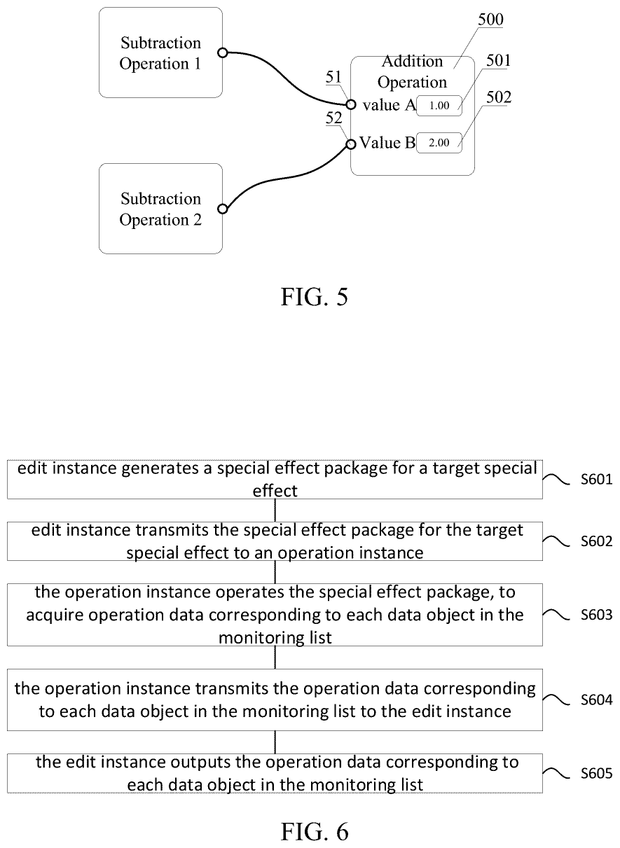

For example, referring to FIG. 5, the running data corresponding to data object “value A” is “1.00”, the running data corresponding to data object “value B” is “2.00”, the node port of the logical node corresponding to data object “value A” is the first input port 51 of the logical node “Addition operation” 500, and the node port of the logical node corresponding to data object “value B” is the second input port 52 of the logical node “Addition operation” 500, the data display area of the first input port 51 of the logical node “Addition operation” 500 is 501, and the data display area of the second input port 52 of the logical node “Addition operation” 500 is 502, therefore, the running data as running data “1.00” is displayed in the data display area 501 corresponding to the first input port 51 of the logical node “Addition operation” 500, and the running data as running data “2.00” is displayed in the data display area 502 corresponding to the second input port 52 of the logical node “Addition operation” 500.

An embodiment of the present disclosure also provides another method for outputting running data of effect. Referring to FIG. 6, the method for outputting the running data of effect may include:
S601: generating, by an edit instance, an effect package for a target effect.
wherein the effect package comprises a monitoring list, and the monitoring list comprises at least one data object of the target effect;
S602: transmitting, by the edit instance, the effect package for the target effect to a running instance.
S603: running, by the running instance, the effect package, to acquire running data corresponding to each data object in the monitoring list.
S604: transmitting, by the running instance, the running data corresponding to each data object in the monitoring list to the edit instance.
S605: outputting, by the edit instance, the running data corresponding to each data object in the monitoring list.

The method for outputting the running data of effect provided in the above embodiment can achieve a technical effect similar to the technical effect that can be achieved by the method for outputting the running data of effect shown in FIG. 3, and will not be repeated in detail here.

Based on the same inventive concept, as the implementation of the above method, an embodiment of the present disclosure also provides an apparatus for outputting running data of effect, which may correspond to the above method embodiments, for the convenience of reading, this apparatus embodiment will not repeat the details of the above method embodiments one by one, but it should be clear that the apparatus for outputting the running data of effect in this embodiment can realize all the contents of the above method embodiments.

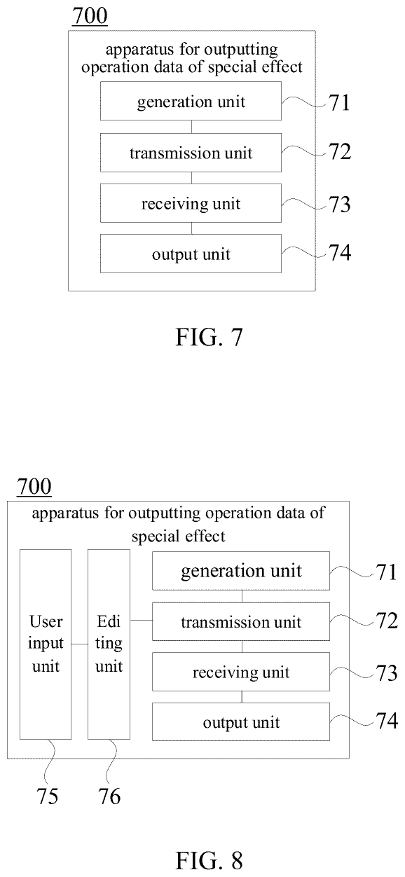

An embodiment of the disclosure provides an apparatus for outputting running data of effect, and an edit instance runs on the apparatus. FIG. 7 is a schematic structural diagram of the apparatus for outputting running data of effect. As shown in FIG. 7, the apparatus 700 for outputting running data of effect may include:
a generation unit 71 configured to generate an effect package for a target effect, wherein the effect package includes a monitoring list, and the monitoring list includes at least one data object of the target effect;
a transmission unit 72 configured to transmit the effect package for the target effect to a running instance;
a receiving unit 73 configured to receive running data corresponding to each data object in the monitoring list transmitted from the running instance; and
an output unit 74 configured to output the running data corresponding to each data object in the monitoring list.

In an embodiment of the present disclosure, as shown in FIG. 8, the apparatus 700 for outputting running data of effect may further include:
an user input unit 75 configured to receive an editing operation input by a user for the effect package for the target effect;
an editing unit 76 configured to edit the effect package for the target effect corresponding to the edit instance based on the editing operation, and
the transmission unit 72 can be further configured to transmit an editing command to the running instance according to the editing operation, wherein the editing command is used for instructing the running instance to edit the effect package for the target effect corresponding to the running instance according to the editing operation;
the receiving unit 73 can be further configured to receive updated data transmitted by the running instance, wherein the updated data includes running data corresponding to each data object in the monitoring list acquired by the running instance running an updated effect package, and the updated effect package is an effect package obtained by the running instance editing the effect package for the target effect according to the editing operation; and
the output unit 74 can be further configured to output the updated data.

In an embodiment of the present disclosure, wherein the generation unit 71 can be specifically configured to load a resource file for the target effect; display at least two logical nodes in response to a node adding operation input by a user; acquire an effect logic for the target effect in response to a connection operation by the user for node ports of the at least two logical nodes; generate the monitoring list in response to at least one data object input by a user; package the monitoring list, the resource file for the target effect, and the effect logic for the target effect to generate the effect package for the target effect.

In an embodiment of the present disclosure, wherein the monitoring list can further include an identifier of a node port of a logical node corresponding to each data object;
the receiving unit 73 can be specifically configured to receive running data corresponding to each data object in the monitoring list and the identifier of the node port of the logical node corresponding to each running data transmitted from the running instance.

In an embodiment of the present disclosure, wherein the identifier of a node port of a logical node corresponding to a data object can include:
an identifier of a node port of a logical node with the data object as input.

In an embodiment of the present disclosure, wherein the outputting unit 74 can be specifically configured to, according to the identifier of the node port of the logical node corresponding to each running data, display each running data in the data display area corresponding to the node port.

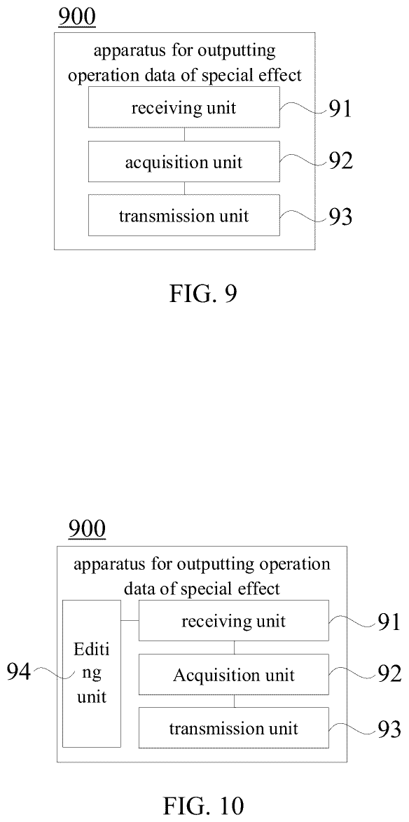

An embodiment of the disclosure provides an apparatus for outputting running data of effect, and a running instance runs on the apparatus. FIG. 9 is a schematic structural diagram of the apparatus for outputting running data of effect, as shown in FIG. 9, the device 900 for outputting running data of effect can include:
a receiving unit 91 configured to receive an effect package for a target effect transmitted from an edit instance, wherein the effect package includes a monitoring list, and the monitoring list includes at least one data object of the target effect;
an acquisition unit 92 configured to acquire running data corresponding to each data object in the monitoring list by running the effect package;
a transmission unit 93 configured to transmit the running data corresponding to each data object in the monitoring list to the edit instance, so that the edit instance outputs the running data corresponding to each data object in the monitoring list.

In an embodiment of the present disclosure, as shown in FIG. 10, the apparatus can further include an editing unit 94;
the receiving unit 91 can be further configured to receive an editing command transmitted from the edit instance, wherein the editing command is used for instructing the running instance to edit the effect package for the target effect corresponding to the running instance according to the editing operation;
the editing unit 94 can be further configured to edit the effect package for the target effect corresponding to the edit instance based on the editing operation, to generate an updated effect package;
the acquisition unit 92 can be further configured to run the updated effect package to acquire updated data, wherein the updated data includes running data corresponding to each data object in the monitoring list acquired by running the updated effect package, and
the transmission unit 93 can be further configured to transmit the updated data to the edit instance.

In an embodiment of the present disclosure, wherein the monitoring list can further include an identifier of a node port of a logical node corresponding to each data object;
the transmission unit 93 can be specifically configured to transmit the edit instance running data corresponding to each data object in the monitoring list and the identifier of the node port of the logical node corresponding to each running data.

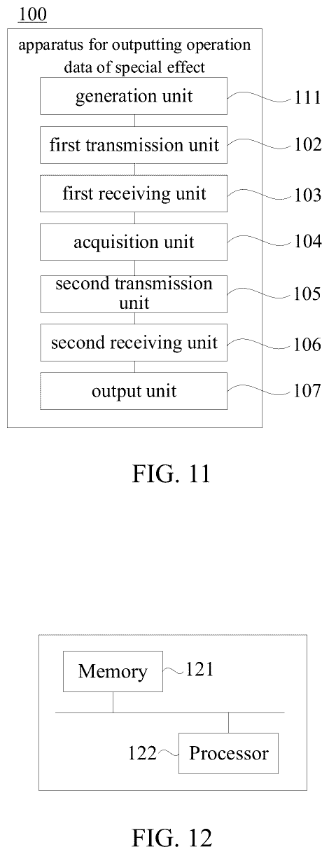

An embodiment of the disclosure provides an apparatus for outputting running data of effect, and an edit instance and a running instance run on the apparatus. FIG. 11 is a schematic structural diagram of the apparatus for outputting running data of effect, as shown in FIG. 11, the device 110 for outputting running data of effect can include:
a generation unit 111 configured to generate, by the edit instance, an effect package for a target effect, wherein the effect package includes a monitoring list, and the monitoring list includes at least one data object of the target effect;
a first transmission unit 112 configured to transmit, by the edit instance, the effect package for the target effect to a running instance;
a first receiving unit 113 configured to receive, by the running instance, the effect package for the target effect transmitted from the edit instance;
an acquisition unit 114 configured to acquire running data corresponding to each data object in the monitoring list by the running instance running the effect package;
a second transmission unit 115 configured to transmit, by the running instance, the running data corresponding to each data object in the monitoring list to the edit instance,
a second receiving unit 116 configured to receive, by the edit instance, running data corresponding to each data object in the monitoring list transmitted from the running instance, and
an output unit 117 configured to output, by the edit instance, the running data corresponding to each data object in the monitoring list.

The apparatus for outputting the running data of effect provided in the above embodiment can execute the method for outputting the running data of effect provided in the above method embodiments, and its implementation principle is similar to the technical effect, so the details are not repeated here.

It should be noted that the above-mentioned units are only divided according to their specific functions, and are not used to limit their specific implementation, for example, they can be implemented in software, hardware or a combination of software and hardware. In an actual implementation, the above units can be realized as separate physical entities, or can also be realized by a single entity (for example, a processor (CPU or DSP, etc.), an integrated circuit, etc.).

In addition, although not shown, the apparatus may also include a memory, which may store various information generated by the apparatus and various units included in the apparatus during operation, programs and data used for operation, data to be transmitted by the communication unit, and the like. The memory may be a volatile memory and/or a non-volatile memory. For example, the memory may include, but not limited to, random access memory (RAM), dynamic random access memory (DRAM), static random access memory (SRAM), read-only memory (ROM), and flash memory. Of course, the memory may also be located outside the apparatus. Alternatively, although not shown, the apparatus may also include a communication unit, which may be used to communicate with other apparatuses. In one example, the communication unit can be implemented in an appropriate manner known in the art, and will not be described in detail here.

Based on the same inventive concept, the embodiment of the present disclosure also provides an electronic device. FIG. 12 is a schematic structural diagram of an electronic device provided by an embodiment of the present disclosure. As shown in FIG. 12, the electronic device provided by this embodiment includes a memory 121 and a processor 122, wherein the memory 121 is used for storing a computer program, the processor 122, when executing the computer program, is used to execute the method of outputting the running data of effect provided in the above embodiments.

An embodiment of the present disclosure also provides a computer-readable storage medium, on which a computer program is stored, which, when executed by a computing device, causes the computing device to realize the method of outputting running data of effect provided in the above embodiments.

An embodiment of the present disclosure also provides a computer program product, which, when running on a computer, causes the computer to realize the method for outputting running data of effect provided in the above embodiments.

An embodiment of the present disclosure also provides a computer program, and the computer program includes program codes which, when executed by a computer, cause the computer to realize the method for outputting the running data of effect provided by the above embodiments.

It should be understood by those skilled in the art that embodiments of the present disclosure can be provided as a method, a system, or a computer program product. Therefore, the present disclosure can take the form of an entire hardware embodiment, an entire software embodiment, or an embodiment combining software and hardware aspects. Moreover, the present disclosure may take the form of a computer program product embodied on one or more computer usable storage media having computer usable program codes embodied therein.

The processor can be a Central Processing Unit (CPU), other general processors, Digital Signal Processor (DSP), application specific integrated circuits (ASIC), Field-Programmable Gate Array (FPGA) or other programmable logic devices, discrete gate or transistor logic devices, discrete hardware components, etc. The general processor can be a microprocessor or the processor can be any conventional processor, etc.

Memory may include non-persistent memory, random access memory (RAM) and/or nonvolatile memory in computer-readable media, such as read-only memory (ROM) or flash memory (flash RAM). Memory is an example of a computer-readable medium.

Computer readable medium may include persistent and non-persistent, removable and non-removable storage medium. The storage medium can store information by any method or technology, and the information can be computer-readable instructions, data structures, program modules or other data. Examples of storage medium for computers may include, but not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, CD-ROM, digital versatile disc (DVD) or other optical storage, magnetic box, magnetic disc storage, or other magnetic storage device or any other non-transmission medium, for storing the information accessible to the computing device. According to the definition in this paper, the computer-readable media do not include temporary computer-readable media, such as modulated data signals and carrier waves.

Finally, it should be explained that the above embodiments are only used to illustrate the technical scheme of this disclosure, but not limit it; although the present disclosure has been described in detail with reference to the foregoing embodiments, it should be understood by those skilled in the art that the technical schemes described in the foregoing embodiments can still be modified, or some or all of its technical features can be replaced by equivalents; however, these modifications or replacements do not make the essence of the corresponding technical solutions deviate from the scope of the technical solutions of various embodiments of the present disclosure.

What is claimed is:

1. A method for outputting running data of effect, wherein the method is applied to an edit instance, and the method comprises:
generating an effect package for a target effect, wherein the effect package comprises a monitoring list including at least one data object of the target effect;
transmitting the effect package for the target effect to a running instance;
receiving running data corresponding to each data object in the monitoring list transmitted from the running instance; and
outputting the running data corresponding to each data object in the monitoring list.

2. The method of claim 1, further comprising:
receiving an editing operation input by a user for the effect package for the target effect;
editing the effect package for the target effect corresponding to the edit instance based on the editing operation, and transmitting an editing command to the running instance according to the editing operation, wherein the editing command is used for instructing the running instance to edit the effect package for the target effect corresponding to the running instance according to the editing operation;
receiving updated data transmitted from the running instance, wherein the updated data comprises running data corresponding to each data object in the monitoring list acquired by the running instance running an updated effect package, and the updated effect package is an effect package obtained by the running instance editing the effect package for the target effect according to the editing operation; and
outputting the updated data.

3. The method of claim 1, wherein the generating the effect package for the target effect, comprises:
loading a resource file for the target effect;
displaying at least two logical nodes in response to a node adding operation input by a user;
acquiring an effect logic for the target effect in response to a connection operation by the user for node ports of the at least two logical nodes;
generating the monitoring list in response to at least one data object input by a user;
packaging the monitoring list, the resource file for the target effect, and the effect logic for the target effect to generate the effect package for the target effect.

4. The method of claim 3, wherein the monitoring list further comprises an identifier of a node port of a logical node corresponding to each data object;
the receiving running data corresponding to each data object in the monitoring list transmitted from the running instance, comprises:
receiving running data corresponding to each data object in the monitoring list and the identifier of the node port of the logical node corresponding to each running data transmitted from the running instance.

5. The method of claim 4, wherein the identifier of a node port of a logical node corresponding to a data object comprises:
an identifier of a node port of a logical node with the data object as input.

6. The method of claim 4, wherein the outputting the running data corresponding to each data object in the monitoring list, comprises:
according to the identifier of the node port of the logical node corresponding to each running data, displaying each running data in the data display area corresponding to the node port.

7-13. (canceled)

14. An electronic device comprising: a memory and a processor, wherein the memory is used for storing a computer program; the processor, when executing the computer program, causes the electronic device to implement:
generating an effect package for a target effect, wherein the effect package comprises a monitoring list including at least one data object of the target effect;
transmitting the effect package for the target effect to a running instance;
receiving running data corresponding to each data object in the monitoring list transmitted from the running instance; and
outputting the running data corresponding to each data object in the monitoring list.

15. A non-transitory computer-readable storage medium having a computer program stored thereon, the computer program, when executed by a computing device, causes the computing device to implement:
generating an effect package for a target effect, wherein the effect package comprises a monitoring list including at least one data object of the target effect;
transmitting the effect package for the target effect to a running instance;
receiving running data corresponding to each data object in the monitoring list transmitted from the running instance; and
outputting the running data corresponding to each data object in the monitoring list.

16. (canceled)

17. The electronic device of claim 14, wherein the processor, when executing the computer program, causes the electronic device to further implement:
receiving an editing operation input by a user for the effect package for the target effect;
editing the effect package for the target effect corresponding to the edit instance based on the editing operation, and transmitting an editing command to the running instance according to the editing operation, wherein the editing command is used for instructing the running instance to edit the effect package for the target effect corresponding to the running instance according to the editing operation;
receiving updated data transmitted from the running instance, wherein the updated data comprises running data corresponding to each data object in the monitoring list acquired by the running instance running an updated effect package, and the updated effect package is an effect package obtained by the running instance editing the effect package for the target effect according to the editing operation; and
outputting the updated data.

18. The electronic device of claim 14, wherein, the generating the effect package for the target effect, comprises:
loading a resource file for the target effect;
displaying at least two logical nodes in response to a node adding operation input by a user;
acquiring an effect logic for the target effect in response to a connection operation by the user for node ports of the at least two logical nodes;
generating the monitoring list in response to at least one data object input by a user;
packaging the monitoring list, the resource file for the target effect, and the effect logic for the target effect to generate the effect package for the target effect.

19. The electronic device of claim 18, wherein the monitoring list further comprises an identifier of a node port of a logical node corresponding to each data object;
the receiving running data corresponding to each data object in the monitoring list transmitted from the running instance, comprises:
receiving running data corresponding to each data object in the monitoring list and the identifier of the node port of the logical node corresponding to each running data transmitted from the running instance.

20. The electronic device of claim 19, wherein the identifier of a node port of a logical node corresponding to a data object comprises:
an identifier of a node port of a logical node with the data object as input.

21. The electronic device of claim 19, wherein the outputting the running data corresponding to each data object in the monitoring list, comprises:
according to the identifier of the node port of the logical node corresponding to each running data, displaying each running data in the data display area corresponding to the node port.

22. The non-transitory computer-readable storage medium of claim 15, wherein the computer program, when executed by a computing device, causes the computing device to further implement:
receiving an editing operation input by a user for the effect package for the target effect;
editing the effect package for the target effect corresponding to the edit instance based on the editing operation, and transmitting an editing command to the running instance according to the editing operation, wherein the editing command is used for instructing the running instance to edit the effect package for the target effect corresponding to the running instance according to the editing operation;
receiving updated data transmitted from the running instance, wherein the updated data comprises running data corresponding to each data object in the monitoring list acquired by the running instance running an updated effect package, and the updated effect package is an effect package obtained by the running instance editing the effect package for the target effect according to the editing operation; and
outputting the updated data.

23. The non-transitory computer-readable storage medium of claim 15, wherein the generating the effect package for the target effect, comprises:
loading a resource file for the target effect;
displaying at least two logical nodes in response to a node adding operation input by a user;
acquiring an effect logic for the target effect in response to a connection operation by the user for node ports of the at least two logical nodes;
generating the monitoring list in response to at least one data object input by a user;
packaging the monitoring list, the resource file for the target effect, and the effect logic for the target effect to generate the effect package for the target effect.

24. The non-transitory computer-readable storage medium of claim 23, wherein the monitoring list further comprises an identifier of a node port of a logical node corresponding to each data object;
the receiving running data corresponding to each data object in the monitoring list transmitted from the running instance, comprises:
receiving running data corresponding to each data object in the monitoring list and the identifier of the node port of the logical node corresponding to each running data transmitted from the running instance.

25. The non-transitory computer-readable storage medium of claim 24, wherein the identifier of a node port of a logical node corresponding to a data object comprises:
an identifier of a node port of a logical node with the data object as input.

26. The non-transitory computer-readable storage medium of claim 24, wherein the outputting the running data corresponding to each data object in the monitoring list, comprises:
according to the identifier of the node port of the logical node corresponding to each running data, displaying each running data in the data display area corresponding to the node port.
